(19) United States
(12) Patent Application Publication
(10) Pub. No.: US 2010/0173119 A1
(43) Pub. Date: Jul. 8, 2010

(54) Narrow fabric with elastomeric coating and flock

(75) Inventors: Ranil Kirthi Vitarana, Colombo (LK); Prins Joseph Benedict Perera, Etul-Kotte (LK); Hans Bauer, Balingen (DE)

Correspondence Address: MORGAN LEWIS & BOCKIUS LLP, 1111 PENNSYLVANIA AVENUE NW, WASHINGTON, DC, 20004, US

(73) Assignee: New Textile Technologies GmbH

(21) Appl. No.: 12/585,970

(22) Filed: Sep. 29, 2009

Related U.S. Application Data
(63) Continuation-in-part of application No. 12/149,504, filed on May 2, 2008.

(51) Int. Cl. B32B 5/02; B05D 1/16; B05D 3/12; B05D 3/14

(52) U.S. Cl. 428/90; 427/463; 427/184

(57) ABSTRACT

A narrow fabric includes an elastomeric coating on at least a portion of at least one side of the narrow fabric to provide designed, localized control and performance in the narrow fabric. Optionally, the elastomeric coating may be embedded with flock fibers.

### FIELD OF THE INVENTION

The invention relates to narrow fabrics, and more particularly, narrow fabrics with an elastomeric adhesive and flocking and a method for manufacturing narrow fabrics with an elastomeric adhesive and flocking.

### DISCUSSION OF THE RELATED ART

Narrow fabrics, such as elastics, are used in a variety of applications in apparel wear, including many types of intimate wear, active wear, and medical wear. In the related art, micro fiber yarns are used in an effort to make the narrow fabric comfortable to the wearer. However, the comfort provided by the micro fiber yarns is low, the aesthetic value is low, and the cost is high. Accordingly, there exists a need for a narrow fabric that is comfortable to the wearer, has high aesthetics, and is not expensive. Further, there exists a need for a narrow fabric that has localized control and performance.

### SUMMARY OF THE INVENTION

Accordingly, the present invention is directed to a narrow fabric with elastomeric coating that substantially obviates one or more of the problems due to limitations and disadvantages of the related art.

In one aspect of the present invention, a narrow fabric with localized control and performance is provided. In certain embodiments, a narrow fabric is described that includes an elastomeric coating on a least a portion of at least one side of the narrow fabric, wherein the coating is located in a portion of the narrow fabric where reduced stretch is desired.

In another aspect of the present invention, a narrow fabric with increased comfort and aesthetics is provided. In certain embodiments, a narrow fabric is described that includes an elastomeric coating and fiber flocking embedded in the elastomeric coating.

The invention will be explained in further detail in conjunction with drawings representing various embodiments. In the drawings and in the following descriptions, further characteristics and advantages associated with the invention are evident.

### BRIEF DESCRIPTION OF THE DRAWINGS

FIG. 1 shows a cross section of a narrow fabric with an elastomeric coating embedded with flocking.

FIG. 2 shows a silkscreen configuration for applying adhesive coating according to one aspect of the present invention.

FIG. 3 shows a spraying configuration for applying adhesive coating according to one aspect of the present invention.

FIG. 4 shows an extrusion configuration for applying adhesive coating according to one aspect of the present invention.

FIG. 5 shows the application of charge and attraction of flocking to the adhesive coating according to one embodiment of the present invention.

### DETAILED DESCRIPTION OF THE PREFERRED EMBODIMENTS

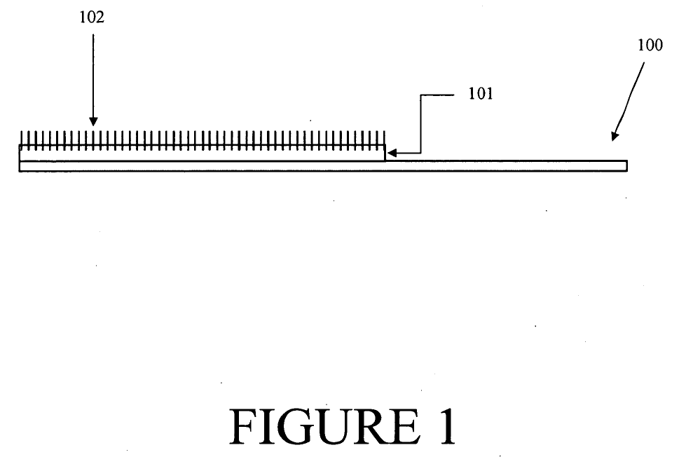

FIG. 1 shows a narrow fabric 100 with an elastomeric coating 101. The elastomeric coating 101 increases the modulus of the narrow fabric in areas where it is applied. Accordingly, the elastomeric coating 101 may be applied on a portion of the narrow fabric 100 where localized control and performance are desired. Thus, a single narrow fabric may provide the flexibility of varied control and performance at multiple desired locations while maintaining its overall elasticity. Optionally, flocking 102 may be embedded in elastomeric coating 101.

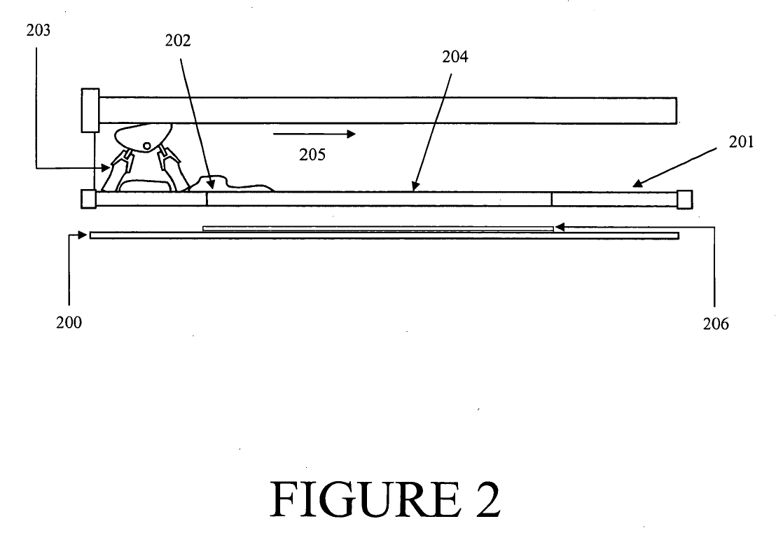

FIG. 2 depicts a silkscreen configuration for applying an elastomeric coating to a narrow fabric. As shown in FIG. 2, a narrow fabric 200 may be placed beneath a silkscreen 201. An elastomeric coating substance 202 may be passed through screen apertures 204 of silkscreen 201 using squeegees 203, which move in the direction of arrow 205. In one embodiment, the elastomeric coating substance 202 is transferred to the narrow fabric 200 by capillary action in controlled and prescribed quantities to form an elastomeric coating 206 on the narrow fabric 200. The apertures 204 may be provided in a wide variety of patterns and squeegees 203 may be operated in a number of orientations and directions. The elastomeric coating 206 forms a three dimension (3D) structure on the narrow fabric 200. The thickness of the 3D structure may be determined by parameters including, but not limited to, the distance between the narrow fabric 200 and the silkscreen 201, the dimension of the apertures 204 of the silkscreen 201, and the viscosity of the elastomeric coating substance 202. Hereinafter, “thickness” refers to the dimension of the elastomeric coating from the elastomeric coating/fabric interface to the top of the elastomeric coating.

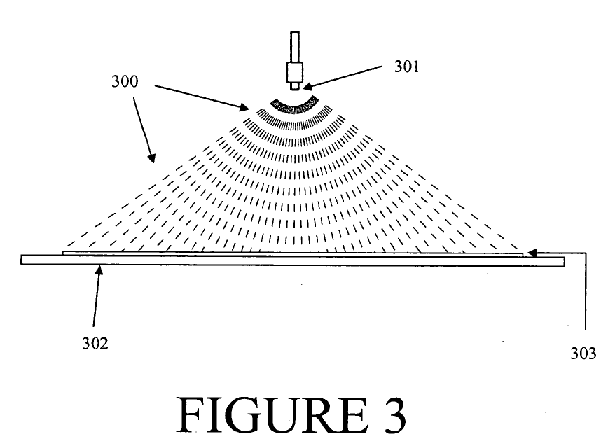

Alternatively, as shown in FIG. 3, an elastomeric coating substance may be sprayed onto a narrow fabric with or without a silkscreen. As shown in FIG. 3, an elastomeric adhesive 300 may be in either liquid or semi-liquid form and may be sprayed under pressure via a nozzle 301 onto a narrow fabric 302 to form an elastomeric adhesive coating 303. The thickness of the coating be varied by varying the nozzle diameter, spraying pressure, and spraying duration. A stencil may also be used to further enhance the process whereby a stencil with a particular pattern is placed on the narrow fabric and the elastomeric coating is sprayed through the stencil onto the narrow fabric in order to achieve required patterns on the narrow fabric.

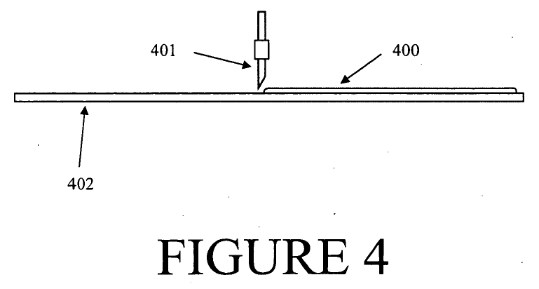

Alternatively, as shown in FIG. 4, an elastomeric coating may be applied to a narrow fabric by a process of extrusion, whereby an elastomeric coating substance 400 is extruded via an extruder 401 onto a narrow fabric 402 in controlled and prescribed quantities, and may be applied in the form of pre-designed patterns with or without the use of stencils.

Optionally, the elastomeric coating 101 may be embedded with flock fibers 102, as shown in FIG. 1. The flock fibers 102 may be small individual cut fiber particles and may be either synthetic or natural. In a preferred embodiment, the flock fibers 102 are attached to the elastomeric coating 101 soon after the elastomeric coating is applied to the narrow fabric while the elastomeric coating exhibits adhesive surface properties (hereinafter referred to as “elastomeric adhesive”) prior to curing. Flock fibers 102 may be attached to elastomeric coating 101 either by electrostatic flocking or mechanical flocking.

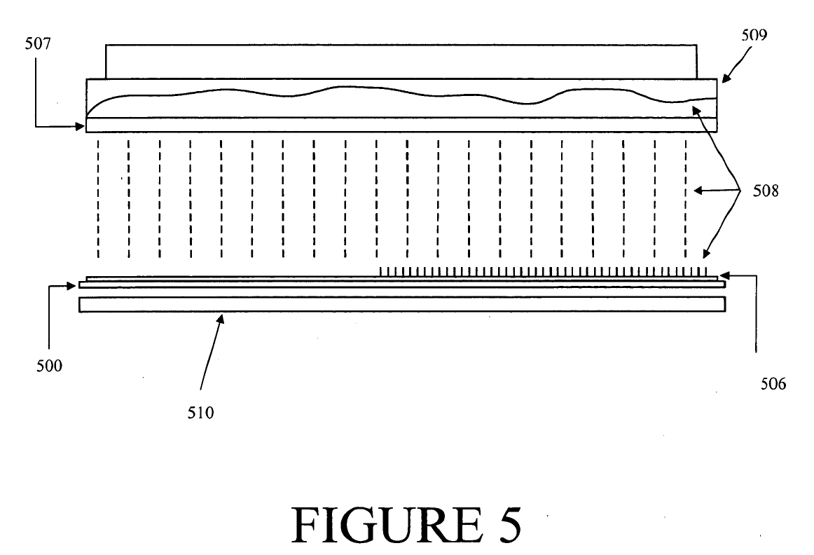

In one embodiment of electrostatic flocking, a portion of the narrow fabric with the elastomeric adhesive may be passed through a fiber metering station in which an electrostatic field is maintained around the elastomeric adhesive. This may involve the application of charge to the flock fibers and attraction of the fibers to the elastomeric adhesive on the narrow fabric as is shown in FIG. 5. A top inducer plate 507 may induce an electrostatic charge to the flock fibers 508 contained in the flock fiber storage compartment 509. A bottom inducer plate 510 may induce an opposite electrostatic charge to the coated narrow fabric 500, resulting in an electrostatic field between the coated narrow fabric 500 and the flock fibers 508. According to this aspect, the flock fibers 508 are attracted to and move towards the narrow fabric 500 and penetrate and embed themselves in the elastomeric adhesive coating 506. In a preferred aspect, the fibers are oriented such that one fiber end is embedded in the elastomeric adhesive coating 506 and the other end of the fiber extends above the elastomeric coating 506 on the narrow fabric 500.

Alternatively, mechanical flocking may be used. The elastomeric adhesive may be coated with flocking by the beater-bar method where the adhesive-coated portion of the narrow fabric may be passed over a series of polygonal rollers that rapidly vibrate the adhesive-coated portion of the narrow fabric. This vibration may drive the flock fibers into the elastomeric adhesive. The elastomeric adhesive may then be cured, anchoring the flocking.

The flock fibers may be colored to improve the visual aesthetics of the narrow fabric. Flocking may be applied to all of the elastomeric coating or only portions of the elastomeric coating. Silicone may be used as the elastomeric coating.

It will be apparent to those skilled in the art that various modifications and variations can be made in the narrow fabric with elastomeric coating and flocking of the present invention without departing from the spirit or scope of the invention. Thus, it is intended that the present invention cover the modifications and variations of this invention provided they come within the scope of the appended claims and their equivalents.

What is claimed is:

1. A narrow fabric assembly comprising:
a narrow fabric and
an elastomeric coating on at least one portion of at least one side of the narrow fabric, wherein
the elastomeric coating is embedded with flock fibers.

2. The narrow fabric assembly of claim 1, wherein the elastomeric coating is located where an increased modulus of the narrow fabric is desired.

3. The narrow fabric assembly of claim 1, wherein the elastomeric coating is silicone.

4. A method of manufacturing a narrow fabric assembly comprising the steps of:
applying an elastomeric coating to a narrow fabric;
passing the narrow fabric and elastomeric coating through a fiber metering station in which an electrostatic field is maintained; and
applying flock fibers in the presence of an electrostatic field.

5. The method according to claim 4, wherein the flock fibers are applied to the elastomeric coating prior to curing of the elastomeric coating.

6. The method according to claim 4, wherein the elastomeric coating is silicone.

7. A method of manufacturing a narrow fabric assembly comprising the steps of:
applying an elastomeric coating to a narrow fabric; applying flock fibers to the elastomeric coating;
passing the narrow fabric with elastomeric coating and flock fibers over at least one polygonal roller that vibrates the portion of the narrow fabric coated with the elastomeric coating thereby embedding the elastomeric coating with flock fibers.

8. The method according to claim 7, wherein the flock fibers are embedded in the elastomeric coating prior to curing of the elastomeric coating.

9. The method according to claim 7, wherein the elastomeric coating is silicone.
